(19) United States
(12) Patent Application Publication
(10) Pub. No.: US 2024/0200655 A1
(43) Pub. Date: Jun. 20, 2024

(54) PRESS-IN-PLACE J-SHAPED SEAL

(71) Applicant: GM GLOBAL TECHNOLOGY OPERATIONS LLC, Detroit, MI (US)

(72) Inventors: Ronald Miller, Bloomfield Hills, MI (US); Abhishek Kumar Sahu, Bengaluru (IN); Purushothama Siddappaji, Bengaluru (IN); Chethan Raj HM, Bangalore (IN)

(73) Assignee: GM GLOBAL TECHNOLOGY OPERATIONS LLC, Detroit, MI (US)

(21) Appl. No.: 18/081,103

(22) Filed: Dec. 14, 2022

(51) Int. Cl. F16J 15/08

(52) U.S. Cl. CPC F16J 15/0818

(57) ABSTRACT

A press-in-place seal for an interface between adjacent components, with the seal including a cylindrical structure arranged along a longitudinal axis and characterized by a J-shape in a cross-sectional view. The seal is arranged inside a first component and compressed by a second component when the PIP seal is installed within the interface. The J-shape includes a first stem section orthogonal to and extending toward the longitudinal axis for being compressed by the second component when the seal is installed within the interface. The J-shape also includes a second stem section longer than the first stem section, orthogonal to and extending toward the longitudinal axis, for stabilizing the structure when the seal is installed. The J-shape further includes a base third section arranged parallel to the longitudinal axis and connecting the first stem section to the second stem section, thereby defining a concavity between the first and second sections.

### INTRODUCTION

The present disclosure relates to a J-shaped press-in-place (PIP) seal, such as for an interface between components from dissimilar materials.

A gasket or seal is a mechanical component that fills the space between mating surfaces, generally to prevent leakage of a fluid from or into the joined objects while the seal is under compression. Seals permit “less-than-perfect” mating surfaces on machine parts to be joined without allowing leakage by using the gasket to fill surface irregularities. Seals also keep external contaminants out of the resultant assembly. Seals are commonly produced from sheet or molded materials such as paper, natural rubber, synthetic rubber, metal, or a plastic polymer.

In situations where a joint between two mating components is pressurized, or the mating components are constructed from dissimilar materials, sealing of such a joint becomes even more challenging. Additionally, in such joints, unintended fluid leakage may lead to functional failure of a system thus being sealed. Typically, such leakage may cause additional inconvenience by creating a fluid spill that necessitates a clean-up. Design and selection of a seal for a particular application may thus prove critical to the reliability of a subject system and to the satisfaction of the system's user.

### SUMMARY

A press-in-place (PIP) seal for an interface between adjacent components, with the PIP seal including a cylindrical structure arranged along a longitudinal axis and characterized by a J-shape in a cross-sectional view. The cylindrical structure is configured to be arranged inside a first component and be compressed by a second component against the first component when the PIP seal is installed within the interface. The J-shape includes a first stem section having a first length arranged orthogonal to and extending toward the longitudinal axis. The first stem is configured to be compressed by the second component to generate sealing pressure between the first and second components when the PIP seal is installed within the interface. The J-shape also includes a second stem section having a second length longer than the first length, arranged orthogonal to and extending toward the longitudinal axis. The second stem is configured to stabilize the cylindrical structure when the PIP seal is installed within the interface. The J-shape further includes a base third section arranged parallel to the longitudinal axis and connecting the first stem section to the second stem section. The third section also defines a concavity between the first and second sections.

The first stem section may include a tip configured to come into contact with the second component when the PIP seal is installed within the interface. The tip may be beveled in the cross-sectional view.

The cylindrical structure may be formed or constructed from an elastic material.

The elastic material may be Ethylene Propylene Diene Monomer (EPDM) rubber.

The material may have Shore A-40 hardness.

The cylindrical structure may be configured to come into contact with a fluid. The PIP seal material may be selected based on its chemical resistance to the fluid.

The fluid may be at least one of moist air, Hydrogen gas, and glycol-based coolant.

Respective transitions between the first stem section, the second stem section, and the base third section may include bends defined by curved profiles.

The cylindrical structure may have a circular or oval contour in a plane orthogonal to the longitudinal axis.

The cylindrical structure may have an irregular contour in a plane orthogonal to the longitudinal axis.

A fluid-pressure joint assembly including first and second components and the press-in-place (PIP) seal for an interface therebetween.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic perspective view of an interface between adjacent components, according to the present disclosure.

FIG. 2 is a schematic close-up perspective view of one embodiment of a J-shaped press-in-place (PIP) seal for the interface shown in FIG. 1, according to the disclosure.

FIG. 3 is a schematic close-up cross-sectional side view of the PIP seal shown in FIG. 1, according to the disclosure.

FIG. 4 is a schematic close-up perspective view of another embodiment of the PIP seal represented by the cross-sectional side view shown in FIG. 3, according to the disclosure.

FIG. 5 is a schematic close-up perspective view of another embodiment of the PIP seal represented by the cross-sectional side view shown in FIG. 3, according to the disclosure.

FIG. 6 is a schematic close-up cross-sectional side view of the PIP seal illustrated in an installed and compressed state within the interface between adjacent components shown in FIG. 1, according to the disclosure.

### DETAILED DESCRIPTION

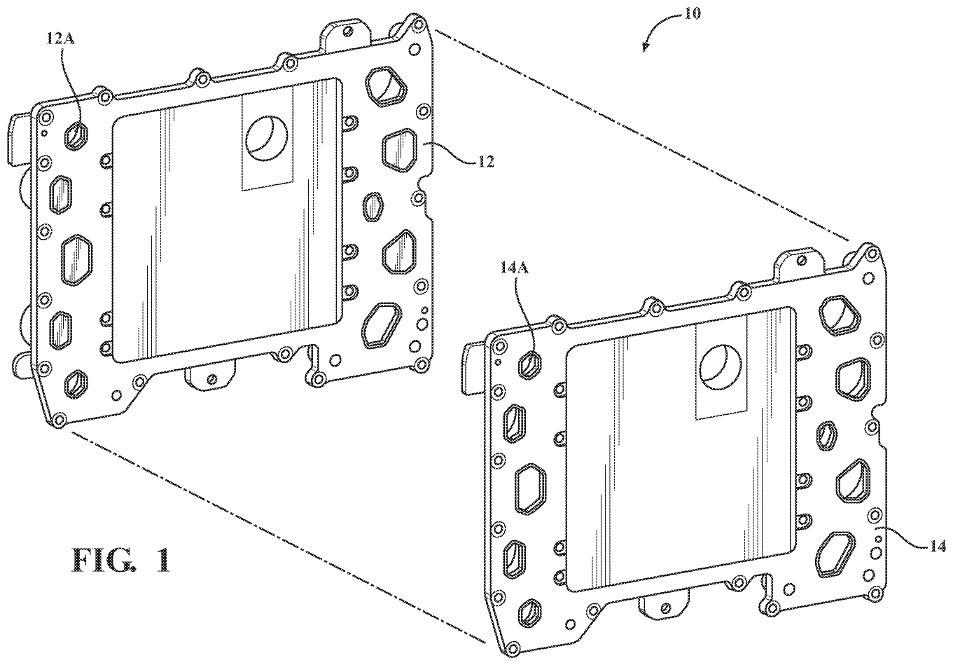

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. Referring to the drawings, wherein like reference numbers refer to like components, FIG. 1 shows an assembly 10 adjacent components—a first component 12, and a second component 14. The assembly 10 includes a joint with an interface 10A (shown in FIG. 6) between components 12 and 14. The interface 10A may be configured to seal a pressurized fluid. Generally, the first component 12 and the second component 14 are fastened to each other to generate a robust assembly.

As shown in FIG. 3, in a cross-sectional view the interface 10A includes a generally annular gap 16 between the first and second components 12, 14 configured to accept a press-in-place (PIP) seal 18 for sealing the interface. The gap 16 is generated between the first and second components 12, 14 when the first component is inserted into the second component. The PIP seal 18 is generally sandwiched and compressed within the gap 16 between the first and second components 12, 14 when the first and second components are fastened together. Controlled deformation of the PIP seal 18 is intended to generate sufficient sealing pressure at the interface 10A without excessive straining of the PIP seal material.

The first and second components 12, 14 may be constructed from different materials having dissimilar coefficients of thermal expansion, such as one of the two components being from metal and the other from plastic. During its operational life, the interface 10A may experience a considerable temperature gradient and gap variation. However, with the PIP seal 18 in place, the interface 10A is intended to withstand and seal considerable fluid pressure. In the assemblies employing the interface 10A with the intent of sealing pressurized fluid, the subject interface may be identified as a “fluid-pressure joint” and with the PIP seal 18 in place, the entire assembly may be identified as a “fluid-pressure joint assembly”.

Typically, a joint is said to have a large gap variation when design and/or manufacturing tolerances of the mating components become a significant percentage of the thickness of the employed seal. In such a situation, under maximum material condition of the mating components, i.e., when such components are to their maximum allowable size, the actual compression of the seal in the assembled joint may exceed approximately 20-35% of its thickness, and lead to additional stress on those components. On the other hand, in such a situation under a minimum material condition of the mating components, i.e., when such components are at their minimum allowable size, compression of the seal may be less than ideally required to retain pressurized fluid without leakage.

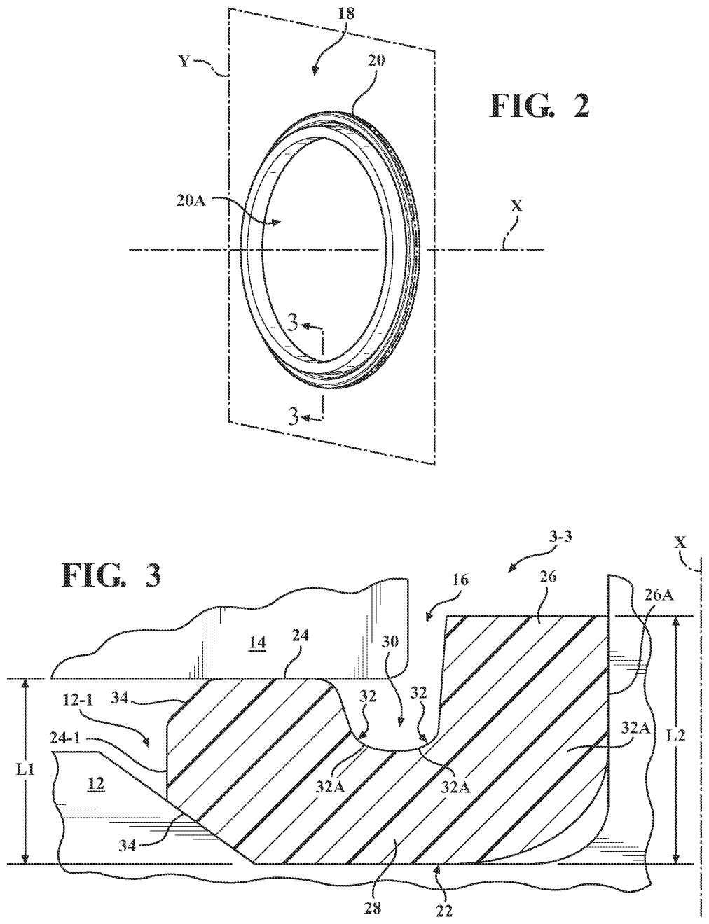

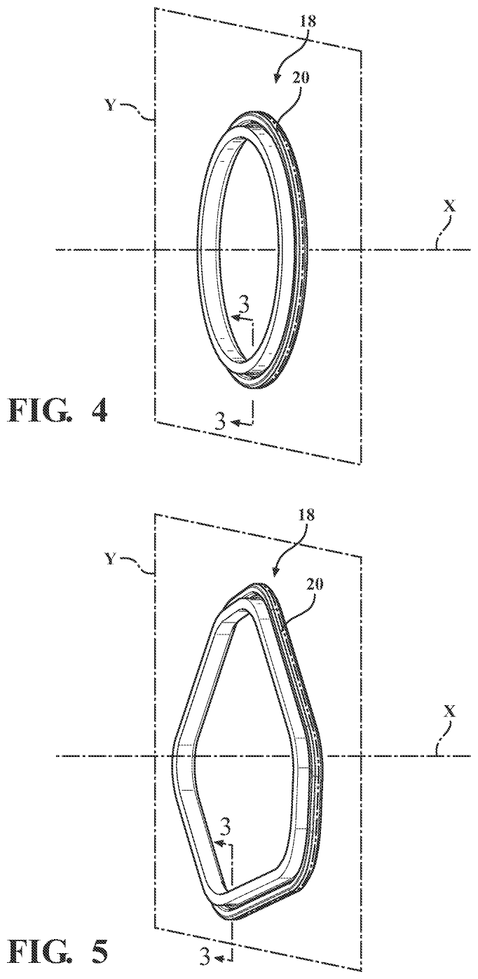

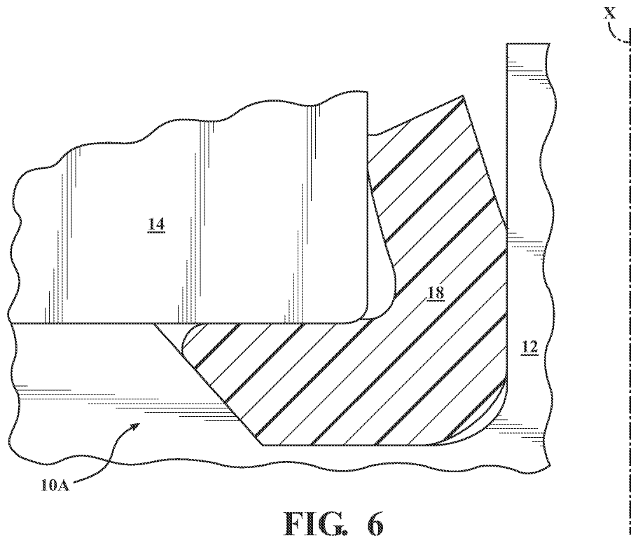

As shown in FIGS. 2, 4, and 5, the PIP seal 18 is a continuous band of material and has a generally cylindrical structure 20 arranged along a longitudinal axis X. The PIP seal 18 may be identified as “mono-structural”, denoting the fact that the cylindrical structure 20 is generated from a uniform, uninterrupted mass of a particular material without parts or sections from a different material affixed thereto. The cylindrical structure 20 may have a circular form (shown in FIG. 2) or an oval form (shown in FIG. 4) in a plane Y orthogonal to the longitudinal axis X. Alternatively, the cylindrical structure 20 may have an irregular contour or form (shown in FIG. 5) in the plane Y orthogonal to the longitudinal axis X to match the shape of a particular interface between the first and second components 12, 14.

As shown in FIG. 1, the first component 12 and the second component 14 may define respective passages 12A and 14A for conveying a fluid therebetween. As additionally shown in FIGS. 2, 4, and 5, the cylindrical structure 20 surrounds an open inner region 20A. The open inner region 20A is configured to accept therein and center a section of the second component 14. Such a connection would generate a continuous fluid passage from the first component 12 to the second component 14, thereby facilitating transfer of a working fluid between the passages 12A, 14A. The cylindrical structure 20 is configured to be arranged within the first component 12, such as inside a formed or machined pocket 12-1, and be compressed by the second component 14 against the first component when the PIP seal 18 is installed within the interface 10A. Accordingly, during assembly of the interface 10A, the PIP seal 18 may be initially pressed into the pocket 12-1 and then be compressed by the second component 14 as the first and second components 12, 14 are fastened to each other.

The cylindrical structure 20 may be formed or otherwise constructed from an elastic or compliant material. More specifically, the material of the cylindrical structure 20 may be selected to have Shore A-40 hardness. The Shore A Hardness scale generally measures the hardness of flexible molded rubbers that range in hardness from very soft and flexible, to medium and somewhat flexible, to hard with almost no flexibility at all. Semi-rigid plastics may also be measured on the high end of the Shore A scale. The compliant material of the PIP seal 18 may be especially useful in an embodiment of the interface 10A required to withstand significant fluid pressure and retain its structural and sealing integrity. For example, in such an embodiment, the cylindrical structure 20 may be compressed to 25-47% of its thickness when the second component 14 is fastened to the first component 12.

In an embodiment where the cylindrical structure 20 is intended to come into contact with and seal off a particular fluid, the specific material of the PIP seal 18 may be selected based on its compatibility with the working fluid conveyed through the interface 10A. Additionally, material of the cylindrical structure 20 may be selected to reliably withstand projected temperature range and pressure at the interface 10A. Specifically, at the interface between the first and second components 12, 14 of a motor vehicle powertrain subassembly, the temperature range may be −30 to +110 degrees Celsius. Also, such a vehicle powertrain embodiment of the interface 10A may be required to seal fluid pressure in the 350 KPa range. Furthermore, the material of the PIP seal 18 may be selected based on its resistance to fluid diffusivity and chemical resistance to the subject fluid. Such a fluid may, for example, be moist air, Hydrogen gas, or glycol-based (˜50% by volume) coolant. An exemplary material for the cylindrical structure 20 which would satisfy the above requirements is Ethylene Propylene Diene Monomer (EPDM) rubber.

The cylindrical structure 20 is further characterized by a J-shape 22 in a cross-sectional view taken along section 3-3 in FIGS. 2, 4, and 5 and shown in FIG. 3. As shown in FIG. 3, the J-shape 22 includes a first stem section 24 having a first length L1 arranged orthogonal to and extending toward the longitudinal axis X. The first stem section 24 is configured to be compressed by the second component 14 to generate sealing pressure between the first and second components 12, 14 when the PIP seal 18 is installed within the interface 10A (shown in FIG. 6). The J-shape 22 also includes a second stem section 26 having a second length L2 and arranged orthogonal to and extending toward the longitudinal axis X. As shown, the second length L2 is longer than the first length L1. The second length L2 is configured to stabilize the cylindrical structure 20 in a direction orthogonal to the longitudinal axis X when the PIP seal 18 is installed within the interface 10A. The second stem section 26 defines a generally planar surface 26A configured to come into contact with the second component 14 when the second component is inserted into the open inner region 20A of the cylindrical structure 20.

The J-shape 22 additionally includes a base third section 28 arranged parallel to the longitudinal axis X. The base third section 28 connects the first stem section 24 to the second stem section 26, thereby defining a concavity or a depression 30 between the first and second sections 24, 26. The depression 30 is configured to facilitate orderly contact between the second component 14 and the first section 24 as well as of the second section 26 with the planar surface 26A. The depression 30 is also configured to minimize the likelihood of contact and/or interference of the second component 14 with the base third section 28. As may be seen in FIG. 3, the J-shape 22 includes transitions 32 between the first stem section 24, the second stem 26, and the base third section 28. As shown, subject transitions 32 may include bends 32A defined by curved or radiused profiles. The curved profiles of the bends 32A may facilitate controlled compression of the PIP seal 18 without individual sections 24, 26, 28 collapsing or folding over during generation of the assembly 10.

The first stem section 24 may include a tip 24-1 configured to come into contact with the second component 14 when the PIP seal 18 is being installed within the interface 10A. The tip 24-1 may be beveled or tapered as shown in the cross-sectional view 2-2 to facilitate insertion of the second component 14 into the open inner region 20A surrounded by the cylindrical structure 20. Tapering of the tip 24-1 may be provided by undercuts 34 shown in FIG. 3. The undercuts 34 may be additionally instrumental in facilitating squeezing of the tip 24-1 between the first and second component 12, 14 within the pocket 12-1 to generate compression of the PIP seal 18 in the fluid-pressure joint and withstand dimensional variation of the constituent parts while delivering reliable leak-free performance.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A press-in-place (PIP) seal for an interface between adjacent components, the PIP seal comprising:
a cylindrical structure arranged along a longitudinal axis and characterized by a J-shape in a cross-sectional view, wherein the cylindrical structure is configured to be arranged inside a first component and be compressed by a second component against the first component when the PIP seal is installed within the interface, and wherein the J-shape includes:
a first stem section having a first length arranged orthogonal to and extending toward the longitudinal axis, and configured to be compressed by the second component to generate sealing pressure between the first and second components when the PIP seal is installed within the interface;
a second stem section having a second length longer than the first length, arranged orthogonal to and extending toward the longitudinal axis, and configured to stabilize the cylindrical structure when the PIP seal is installed within the interface; and
a base third section arranged parallel to the longitudinal axis and connecting the first stem section to the second stem section, thereby defining a concavity between the first and second sections.

2. The PIP seal of claim 1, wherein the first stem section includes a tip configured to come into contact with the second component when the PIP seal is installed within the interface, and wherein the tip is beveled in the cross-sectional view.

3. The PIP seal of claim 1, wherein the cylindrical structure is constructed from a compliant material.

4. The PIP seal of claim 3, wherein the compliant material is Ethylene Propylene Diene Monomer (EPDM) rubber.

5. The PIP seal of claim 3, wherein the material has Shore A-40 hardness.

6. The PIP seal of claim 3, wherein the cylindrical structure is configured to come into contact with a fluid, and wherein the material is selected based on its chemical resistance to the fluid.

7. The PIP seal of claim 6, wherein the fluid is at least one of moist air, Hydrogen gas, and glycol-based coolant.

8. The PIP seal of claim 1, wherein respective transitions between the first stem section, the second stem section, and the base third section include bends defined by curved profiles.

9. The PIP seal of claim 1, wherein the cylindrical structure has one of a circular and an oval form in a plane orthogonal to the longitudinal axis.

10. The PIP seal of claim 1, wherein the cylindrical structure has an irregular form in a plane orthogonal to the longitudinal axis.

11. A fluid-pressure joint assembly comprising:
a first component and a second component;
a press-in-place (PIP) seal for an interface between the first and second components, the PIP seal having:
a cylindrical structure arranged along a longitudinal axis and characterized by a J-shape in a cross-sectional view, wherein the cylindrical structure is configured to be arranged inside a first component and be compressed by a second component against the first component when the PIP seal is installed within the interface, and wherein the J-shape includes:
a first stem section having a first length arranged orthogonal to and extending toward the longitudinal axis, and configured to be compressed by the second component to generate sealing pressure between the first and second components when the PIP seal is installed within the interface;
a second stem section having a second length longer than the first length, arranged orthogonal to and extending toward the longitudinal axis, and configured to stabilize the cylindrical structure when the PIP seal is installed within the interface; and
a base third section arranged parallel to the longitudinal axis and connecting the first stem section to the second stem section, thereby defining a concavity between the first and second sections.

12. The fluid-pressure joint assembly of claim 11, wherein the first stem section includes a tip configured to come into contact with the second component when the PIP seal is installed within the interface, and wherein the tip is beveled in the cross-sectional view.

13. The fluid-pressure joint assembly of claim 11, wherein the cylindrical structure is constructed from a compliant material.

14. The fluid-pressure joint assembly of claim 13, wherein the compliant material is Ethylene Propylene Diene Monomer (EPDM) rubber.

15. The fluid-pressure joint assembly of claim 13, wherein the material has Shore A-40 hardness.

16. The fluid-pressure joint assembly of claim 13, wherein the cylindrical structure is configured to come into contact with a fluid, and wherein the material is selected based on its chemical resistance to the fluid.

17. The fluid-pressure joint assembly of claim 16, wherein the fluid is at least one of moist air, Hydrogen gas, and glycol-based coolant.

18. The fluid-pressure joint assembly of claim 11, wherein respective transitions between the first stem section, the second stem section, and the base third section include bends defined by curved profiles.

19. The fluid-pressure joint assembly of claim 11, wherein the cylindrical structure has one of a circular, an oval, and an irregular form in a plane orthogonal to the longitudinal axis.

20. A press-in-place (PIP) seal for an interface between adjacent components, the PIP seal comprising:
a cylindrical structure constructed from Ethylene Propylene Diene Monomer (EPDM) rubber and arranged along a longitudinal axis and characterized by a J-shape in a cross-sectional view, wherein the cylindrical structure is configured to be arranged inside a first component and be compressed by a second component against the first component when the PIP seal is installed within the interface, and wherein the J-shape includes:
a first stem section having a first length arranged orthogonal to and extending toward the longitudinal axis, and configured to be compressed by the second component to generate sealing pressure between the first and second components when the PIP seal is installed within the interface;
a second stem section having a second length longer than the first length, arranged orthogonal to and extending toward the longitudinal axis, and configured to stabilize the cylindrical structure when the PIP seal is installed within the interface; and
a base third section arranged parallel to the longitudinal axis and connecting the first stem section to the second stem section, thereby defining a concavity between the first and second sections.
